(19) United States
(12) Patent Application Publication
(10) Pub. No.: US 2023/0019792 A1
(43) Pub. Date: Jan. 19, 2023

(54) CLAMPING DEVICE FOR INTELLIGENT APPARATUS AND MULTIFUNCTIONAL AUTOMOBILE NECK PILLOW

(71) Applicant: Shenzhen Huimeng Business Information Technology Co.,Ltd, Shenzhen (CN)

(72) Inventor: Yanli Wang, Huizhou (CN)

(21) Appl. No.: 17/406,635

(22) Filed: Aug. 19, 2021

(30) Foreign Application Priority Data
Jul. 16, 2021 (CN) 202121623516.3
Jul. 16, 2021 (CN) 202121625415.X

(51) Int. Cl. B60N 2/882

(52) U.S. Cl. CPC B60N 2/882; B60N 2002/899

(57) ABSTRACT

The technical field of automobile accessories is related to and a clamping device for an intelligent apparatus and a multifunctional automobile neck pillow are provided. The clamping device includes: a T-shaped fixing seat, used to be fixed onto an automobile seat; and a plate clamping mechanism, arranged in the fixing seat and used to clamp the intelligent apparatus. The plate clamping mechanism includes: a first clamping block, arranged in the fixing seat and being L-shaped; and a second clamping block, slidably connected into the first clamping block. The first clamping block and the second clamping block are used to clamp the intelligent apparatus. When the clamping device is used, the fixing seat is fixed to a headrest of the automobile seat, and the intelligent apparatus can be clamped by the plate clamping mechanism, thereby facilitating a rear passenger to use the intelligent apparatus.

### TECHNICAL FIELD

The disclosure relates to the technical field of automobile accessories, and particularly to a clamping device for an intelligent apparatus and a multifunctional automobile neck pillow.

### DESCRIPTION OF RELATED ART

Nowadays, the design of an automobile seat intends to gain a better safety protection for drivers and passengers, and materials used for the seat become more and more sophisticated and softer, however, the drivers and the passengers still feel cervical fatigue after sitting in an automobile for a long time. Therefore, many drivers and passengers often choose to buy and use an automobile neck pillow, and the automobile neck pillow not only can improve the comfort of the drivers and the passengers, but also can play a more important role in protecting the safety of the drivers and passengers. Specifically, the automobile neck pillow can not only protect the cervical vertebras of the drivers and the passengers when the automobile in which the drivers and the passenger are sitting in are crashed, but also relieve the fatigue of the cervical vertebras of the drivers and the passengers, and further make the drivers and the passengers feel more comfortable when sleeping.

However, at present, the existing automobile neck pillow has a single function, and an intelligent apparatus cannot be fixed when the intelligent apparatus is used by a rear passenger of an automobile. As such, the disclosure provides a clamping device for an intelligent apparatus and a multifunctional automobile neck pillow.

### SUMMARY

The disclosure aims to provide a clamping device for an intelligent apparatus and a multifunctional automobile neck pillow, thereby solving an existing technical problem that a rear passenger of an automobile cannot fix an intelligent apparatus to an automobile seat.

In order to achieve the above purpose, the disclosure provides the following technical solutions.

It is provided a clamping device for an intelligent apparatus, adapted for fixing the intelligent apparatus onto an automobile seat, and the clamping device includes: a T-shaped fixing seat, used to be fixed to the automobile seat; and a plate clamping mechanism, arranged in the fixing seat and used to clamp the intelligent apparatus; where the plate clamping mechanism includes: a first clamping block, arranged in the fixing seat and being L-shaped; and a second clamping block, slidably connected into the first clamping block, where the first clamping block and the second clamping block are used to cooperatively clamp the intelligent apparatus.

In an embodiment, the fixing seat includes: a T-shaped fixing housing, being hollow inside; two groups of clamping portions, slidably connected into the fixing housing, respectively arranged at two ends of a part of the fixing housing parallel with a neck pillow body, and used to fix the fixing seat on the automobile seat; and second springs, arranged in the fixing housing and used to respectively press the two groups of clamping portions against the automobile seat.

In an embodiment, the clamping device further includes: a first limiting slot, located in the fixing seat; a telescopic bar, rotatably connected onto the first clamping block, and slidably arranged in the first limiting slot; and an adjustment button, arranged in the fixing seat and used to fix the telescopic bar in the first limiting slot.

In an embodiment, the clamping device further includes: a sixth spring, arranged in the telescopic bar, where two ends of the sixth spring are respectively abutted against the telescopic bar and the fixing seat, and the sixth spring is used to eject the plate clamping mechanism from the fixing seat.

In an embodiment, the plate clamping mechanism further includes: shafts, fixedly connected onto the second clamping block, and slidably connected into the first clamping block; and fifth springs, sleeved on the spring shafts, where an end of the fifth spring abuts against an end of the spring shaft facing away from the second clamping block and the other end of the fifth spring abuts against the first clamping block, and the fifth springs are used to control the second clamping block to clamp the intelligent apparatus.

A multifunctional automobile neck pillow is provided, which includes any one of the clamping devices for an intelligent apparatus described above, and the multifunctional automobile neck pillow further includes: a neck pillow body, fixedly connected to the fixing seat; and a hook, arranged on the fixing seat and used for hanging an object.

In an embodiment, the neck pillow further includes: an adjusting seat, fixedly connected to the neck pillow body and used to adjust a distance between the plate clamping mechanism and the neck pillow body, where an end of the fixing seat near to the neck pillow body is arranged in the adjusting seat.

In an embodiment, a portion of the fixing seat arranged in the adjusting seat is provided with equidistantly arranged limiting tooth slots, and the adjusting seat includes: an adjusting housing, fixedly connected to the neck pillow body and being hollow inside, where the fixing seat is slidably connected to the adjusting housing; a locking button, hinged to a side of the adjusting housing and used to fix the fixing seat, where the locking button is with a second limiting tooth; and a fourth spring, arranged in the adjusting housing and used to press the second limiting tooth in one of the limiting tooth slots.

In an embodiment, the neck pillow further includes: a neck pillow connecting structure, fixedly connected to the neck pillow body and used to adjust a height of the neck pillow body, where the adjusting seat is detachably connected to the neck pillow connecting structure.

In an embodiment, the adjusting housing is provided with a guide rail slot, which is a U-shaped slot provided on two sides of the adjusting housing. The neck pillow connecting structure includes: a fixing plate, fixedly connected to the neck pillow body; and mounting guide rails, fixedly connected to the fixing plate and being L-shaped structures arranged on two sides of the fixing plate, where the mounting guide rails are clamped in the guide rail slots.

In summary, compared with the prior art, the disclosure has the following beneficial effects.

When the clamping device is used, the fixing seat is fixed to a headrest of the automobile seat, and the intelligent apparatus can be clamped by the plate clamping mechanism, thereby facilitating a rear passenger to use the intelligent apparatus.

The neck pillow body can facilitate a user to lean on and reduce the fatigue of the user, and the hook is able to be arranged at the back of the automobile seat, which is convenient for the user to mount an object. The multifunctional automobile neck pillow has the functions of hanging the object, relieving fatigue and facilitating the user to fix the intelligent apparatus. With the neck pillow connecting structure for the neck pillow body of the disclosure, when the height of the neck pillow body is adjusted, it is not only convenient to operate, but it is also time-saving and labor-saving. Further, the neck pillow connecting structure can replace the existing bolt fixing manner.

### BRIEF DESCRIPTION OF THE DRAWINGS

FIG. 1 is a schematic structural view of a clamping device for an intelligent apparatus according to an embodiment of the disclosure;

FIG. 2 is an exploded view of a fixing seat according to an embodiment of the disclosure;

FIG. 3 is an exploded view of a plate clamping mechanism according to an embodiment of the disclosure;

FIG. 4 is a schematic structural view of a multifunctional automobile neck pillow according to an embodiment of the disclosure;

FIG. 5 is a schematic view of a connection manner of an adjusting seat according to an embodiment of the disclosure;

FIG. 6 is a schematic structural view of a fixing seat and an adjusting seat according to an embodiment of the disclosure;

FIG. 7 is an exploded view of a neck pillow connection structure according to an embodiment of the disclosure;

FIG. 8 is a schematic view of a connection manner of a neck pillow connection structure and an adjusting seat of the disclosure;

FIG. 9 is a schematic structural view of a neck pillow connecting structure according to an embodiment of the disclosure;

FIG. 10 is a schematic structural view of another neck pillow connecting structure according to an embodiment of the disclosure;

FIG. 11 is a schematic structural view of another neck pillow connecting structure according to an embodiment of the disclosure;

FIG. 12 is a schematic structural view of another neck pillow connecting structure according to an embodiment of by the disclosure; and

FIG. 13 is a schematic structural view of another neck pillow connecting structure according to an embodiment of by the disclosure.

Reference numerals: 100—Neck pillow body; 200—Neck pillow connecting structure; 201—Base plate; 202—Fixing plate; 203—Limiting plate; 204—First spring; 205—Mounting plate; 206—Spring limiting cylinder; 207—First limiting teeth; 208—Pressing plate; 209—Mounting guide rail; 300—Fixing seat; 301—Fixing housing, 302—Clamping portion; 220—Installation portion; 221—First sliding groove; 230—Locking device; 231—Groove; 232—Rotating shaft; 233—Elastic member; 303—Second spring; 304—Protective pad; 305—Clamping guide rail; 306—Toothed column; 307—Adjustment button; 308—Third spring; 309—Stop cover; 310—Hook; 311—Clamping rack; 312—Limiting tooth slot; 313—First limiting slot; 314—Second limiting slot; 400—Adjusting seat; 401—Adjusting housing; 402—Locking button; 403—Fourth spring; 404—Limiting push plate; 405—Second limiting tooth; 406—Rotating shaft; 407—Unlocking button; 408—Guide rail slot; 420—Assembly portion; 421—Moving plate; 422—Second sliding groove; 500—Plate clamping mechanism; 501—First clamping block; 502—Telescopic bar; 503—Second clamping block; 504—Fifth spring; 505—Dust—proof plate; 506—Clamping pad; 507—Spring shaft; 508—Spring retaining cap; 509—Spring slot; 600—Sixth spring.

### DETAILED DESCRIPTION OF EMBODIMENTS

The technical solutions of embodiments of the disclosure will be described hereinafter clearly and completely with reference to drawings of the embodiments of the disclosure. It is apparent that the described embodiments are only parts of the embodiments of the disclosure, but not all of them. Based on the embodiments of the disclosure, all other embodiments obtained by ordinary technicians in the field without creative labor belong to the scope of protection of the disclosure.

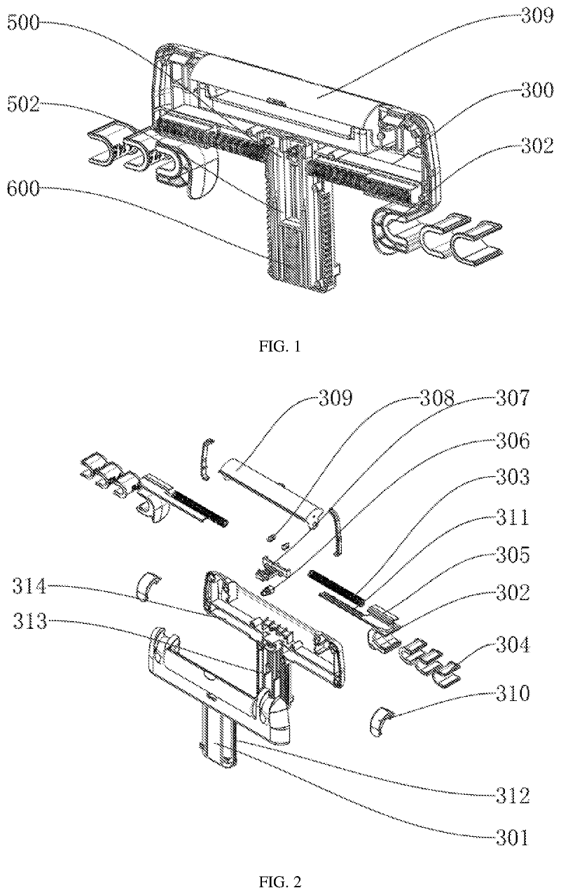

Referring to FIG. 1, an embodiment of the disclosure provides a clamping device for an intelligent apparatus, for fixing the intelligent apparatus onto an automobile seat, and the clamping device includes a T-shaped fixing seat 300 and a plate clamping mechanism 500.

The T-shaped fixing seat 300 is used to be fix onto the automobile seat.

The plate clamping mechanism 500 is arranged in the fixing seat 300 and used to clamp the intelligent apparatus.

In an embodiment, the plate clamping mechanism 500 (referring to FIG. 3) may include a first clamping block 501 and a second clamping block 503.

The first clamping block 501 is arranged in the fixing seat 300, and is L-shaped.

The second clamping block 503 is slidably connected into the first clamping block 501, and the first clamping block 501 and the second clamping block 503 are used to cooperatively clamp the intelligent apparatus.

When the clamping device of the disclosure is used, the fixing seat 300 is fixed to a headrest of the automobile seat, and in order to clamp the intelligent apparatus, the second clamping block 503 is sided to place the intelligent apparatus onto the first clamping block 501, such that the second clamping block 503 and the first clamping block 501 together clamp the intelligent apparatus on the plate clamping mechanism 500, thereby facilitating a rear passenger of the automobile to use the intelligent apparatus.

Referring to FIG. 2, in an embodiment of the disclosure, the fixing seat 300 may include a T-shaped fixing housing 301, two groups of clamping portions 302 and second springs 303.

Specifically, the T-shaped fixing housing 301 is hollow inside.

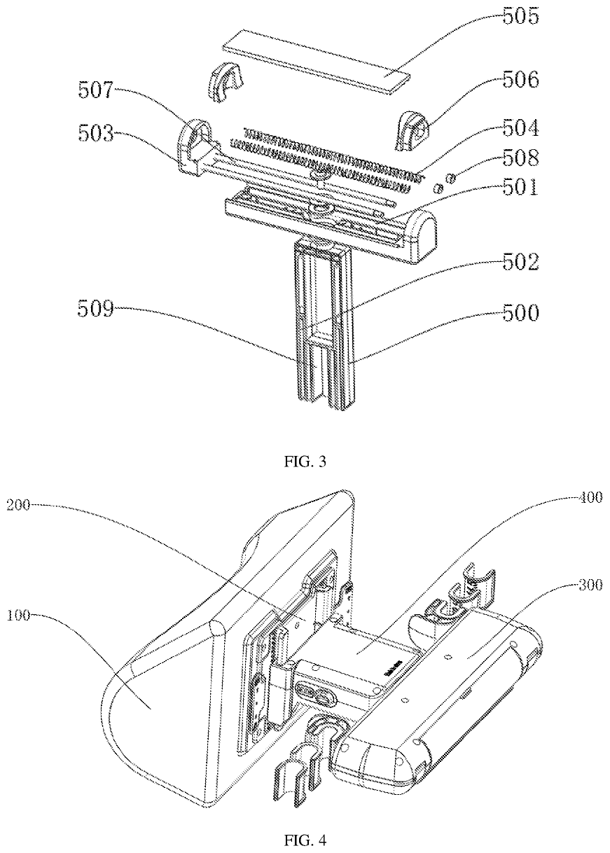

The two groups of clamping portions 302 are slidably connected into the fixing housing 301, and the two groups of clamping portions 302 are respectively arranged at two ends of a part of the fixing housing 301 parallel with a neck pillow body 100 (referring to FIG. 4) and are used to fix the fixing seat 300 on the automobile seat.

The second springs 303 are arranged in the fixing housing 301 and used to respectively press the clamping portions 302 against the automobile seat.

When the fixing seat 300 is fixed, the clamping portions 302 are pressed, such that the clamping portions 302 slide in the fixing housing 301, the fixing housing 301 is placed under the headrest of the automobile seat, and then the clamping portions 302 are released, such that the clamping portions 302 are pressed on a supporting rod of the headrest under a pressure of the second springs 303, therefore, the fixing seat 300 is fixed on the automobile seat.

In some examples, the fixing housing 301 is formed by fixedly connecting two groups of enclosures with the same structure.

As a preferred implementation of the embodiment, each of the clamping portions 302 may be provided with a semi-circular groove, such that the clamping portion 302 can be sleeved on the supporting rod of the headrest of the automobile seat, thereby improving a connection stability between the clamping portion 302 and the supporting rod.

As a preferred implementation of the embodiment, each of the clamping portions 302 is further provided with a clamping guide rail 305, and the fixing housing 301 is further provided with a second limiting slot 314. The clamping guide rail 305 can slide in the second limiting slot 314, such that two ends of each of the second springs 303 respectively abut against the fixing housing 301 and the clamping guide rail 305, thereby the corresponding clamping portion 302 is prevented from being shaken.

In an embodiment, the fixing seat 300 may further include two groups of clamping racks 311 and a toothed column 306.

Specifically, each of the two groups of clamping racks 311 is arranged on the corresponding clamping guide rail 305, and the two groups of clamping racks 311 are positioned respectively at two ends of the fixing housing 301 and oppositely arranged.

The toothed column 306 is rotatably connected into the fixing housing 301, and straight teeth are uniformly distributed on the toothed column 306. The toothed column 306 is arranged between the two groups of clamping racks 311 and used to improve a stability of the clamping portions 302.

Preferably, the semi-circular groove is fixedly connected to a protective pad 304. The protective pad 304 is a rubber pad and fixedly connected to the semi-circular groove by gluing or a screw.

In an embodiment of the disclosure, at least two hooks 310 are arranged on the fixing housing 301, and are curved, hinged on the fixing housing 301. The at least two hooks 310 are distributed respectively at two ends of the fixing housing 301 for hanging an object.

Referring to FIG. 3, in an embodiment of the disclosure, the plate clamping mechanism 500 may further include shafts 507 (also referred to be as shafts) and fifth springs 504.

The spring shaft 507 is fixedly connected onto the second clamping block 503 and slidably connected into the first clamping block 501.

The fifth springs 504 are sleeved on the spring shafts 507. An end of each of the fifth springs 504 abuts against an end of a corresponding one of the spring shafts 507 facing away from the second clamping block 503 and the other end of the fifth spring 504 abuts against the first clamping block 501. The fifth springs 504 are used to control the second clamping block 503 to clamp the intelligent apparatus.

When the intelligent apparatus is required to be clamped, the second clamping block 503 is slid and drives the spring shafts 507 to slide in the first clamping block 501 to enable the fifth springs 504 to be in a compressed state, and then the fifth springs 504 drive the second clamping block 503 to compress intelligent apparatus through the spring shafts 507 after the second clamping block 503 is released.

In some examples, the spring shafts 507 are fixedly connected to the second clamping block 503 by a threaded connection, and a spring retaining cap 508 is arranged at an end of each of the spring shafts 507 facing away from the second clamping block 503. The spring retaining cap 508 is used to press the fifth springs 504 onto the spring shafts 507 and thus prevents the fifth spring 504 from separating from the spring shaft 507.

In some examples, the fifth springs 504 may be fixed by nuts or spring retaining rings.

As a preferred implementation of the embodiment, each of the first clamping block 501 and the second clamping block 503 is further provided with a clamping pad 506, and the clamping pad 506 is a rubber block for protecting the intelligent apparatus.

In some examples, the first clamping block 501 is further provided with a dust-proof plate 505, which is fixed to the first clamping block 501 by a screw. The first clamping block 501 is provided with an opening corresponding to the dust-proof plate 505, and the opening is used for convenient installation of the spring shafts 507 and the fifth springs 504.

Referring to FIGS. 1, 2 and 3, in an embodiment of the disclosure, the clamping device may further include a first limiting slot 313, a telescopic bar 502 and an adjustment button 307.

The first limiting slot 313 is located in the fixing seat 300.

The telescopic bar 502 is rotatably connected onto the first clamping block 501, and slidably arranged in the first limiting slot 313.

The adjustment button 307 is arranged in the fixing seat 300, and is used to fix the telescopic bar 502 in the first limiting slot 313.

When the plate clamping mechanism 500 is used, the plate clamping mechanism 500 is pulled out from the fixing seat 300 through making the telescopic bar 502 slide in the first limiting slot 313. When the plate clamping mechanism 500 is not used, the plate clamping mechanism 500 can be placed in the fixing seat 300, thereby reducing a size of the clamping device of the disclosure.

In some examples, the telescopic bar 502 is provided with a sliding hole passing through the telescopic bar 502. The adjustment button 307 is T-shaped, the adjustment button 307 passes through the sliding hole and is arranged outside the fixing seat 300. The fixing seat 300 is also provided with a third spring 308, which presses the adjustment button 307 against the telescopic bar 502. When the plate clamping mechanism 500 is required to be pulled out from the fixing seat 300, the adjustment button 307 is pressed, and then the adjustment button 307 compresses the third spring 308, such that the adjustment button 307 is separated from the telescopic bar 502; and when a position of the telescopic bar 502 is adjusted properly, the adjustment button 307 is released, and the third spring 308 presses the adjustment button 307 against the telescopic bar 502, thereby preventing the telescopic bar 502 from being separated from the adjustment button 307.

In some examples, the telescopic bar 502 may be mounted onto the first clamping block 501 by a screw, and may rotate around an axis of the screw.

In an embodiment of the disclosure, the clamping device may further include a sixth spring 600.

The sixth spring 600 is arranged in the telescopic bar 502, and two ends of the sixth spring 600 respectively abut against the telescopic bar 502 and the fixing seat 300. The sixth spring 600 is used to eject the plate clamping mechanism 500 from the fixing seat 300.

In some examples, the telescopic bar 502 may be provided with a spring slot 509, and the sixth spring 600 is provided in the spring slot 509.

As a preferred implementation of the embodiment, the fixing seat 300 may further include a stop cover 309.

The stop cover 309 is hinged to the fixing seat 300, an opening for the plate clamping mechanism 500 to enter or exit is provided on the fixing seat 300, and the stop cover 309 is hinged at the opening to prevent the plate clamping mechanism 500 from being ejected from the fixing seat 300.

The stop cover 309 is arc-shaped, and each end of the stop cover 309 is provided with fan-shaped mounting surface, which is provided with a hinge shaft.

Referring to FIG. 4, the disclosure also provides a multifunctional neck pillow (also referred to be as a multifunctional automobile neck pillow), which includes the clamping device described in any one of the above embodiments, and further includes a neck pillow body 100 and a hook 310 (referring to FIG. 2).

The neck pillow body 100 is fixedly connected to the fixing seat 300.

The hook 310 is arranged on the fixing seat 300 and used for hanging an object.

When the multifunctional neck pillow of the disclosure is used, the fixing seat 300 is fixed at a headrest of a seat of an automobile, the neck pillow body 100 can facilitate a user to lean on and reduce the fatigue of the user, the hook 310 is able to be arranged at the back of the automobile seat, which is convenient for the user to mount an object, for example, an automobilery-on bag and so on. The plate clamping mechanism 500 can clamp an intelligent apparatus, such as tablets, mobile phones and the like, which is convenient for the user during clamping the intelligent apparatus to slide the second clamping block 503 and place the intelligent apparatus on the first clamping block 501, such that the second clamping block 503 and the first clamping block 501 clamp the intelligent apparatus on the plate clamping mechanism 500, thus facilitating the passengers in a rear row of the automobile to use the intelligent apparatus.

The multifunctional neck pillow of the disclosure has functions of hanging an object, relieving fatigue and facilitating the user to fix the intelligent apparatus.

In some examples of the embodiment, a structure of the neck pillow body 100 is the same as that of a clamping device in the prior art and will not be repeated herein.

In some examples, the hook 310 is arranged on the fixing housing 301. The hook 310 is curved and hinged on the fixing housing 301. There are two groups of hooks 310, which are distributed respectively at two ends of the fixing housing 301 and used for hanging an object.

In an embodiment of the disclosure, the neck pillow may further include an adjusting seat 400.

The adjusting seat 400 is fixedly connected to the neck pillow body 100 and is used to adjust a distance between the plate clamping mechanism 500 and the neck pillow body 100, such that the neck pillow can be clamped on the automobile seat, and an end of the fixing seat 300 near to the neck pillow body 100 is arranged in the adjusting seat 400.

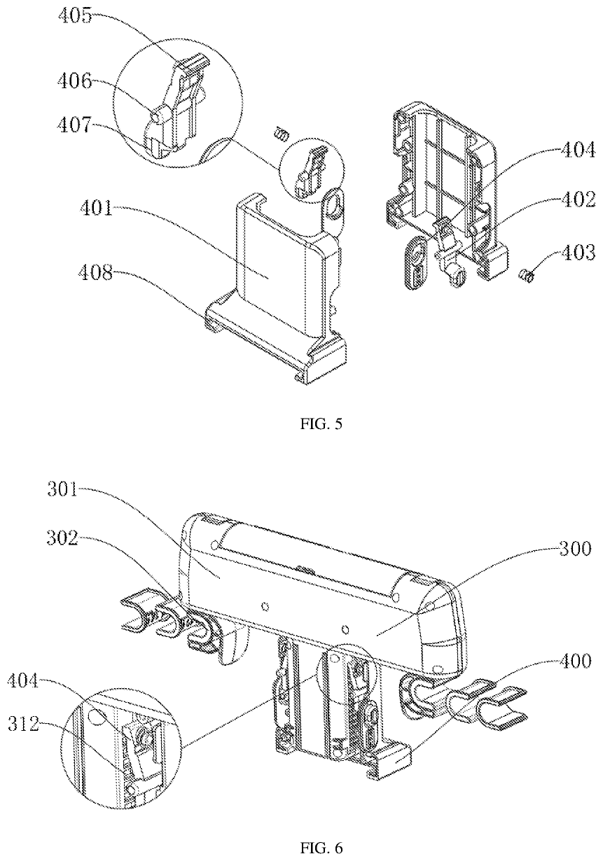

Referring to FIGS. 5 and 6, a portion of the fixing seat 300 arranged in the adjusting seat 400 is provided with equidistantly arranged limiting tooth slots 312, and the adjusting seat 400 includes an adjusting housing 401, a locking button 402 and a fourth spring 403.

The adjusting housing 401 is fixedly connected to the neck pillow body 100 and is hollow inside. The fixing seat 300 is slidably connected to the adjusting housing 401.

The locking button 402 is hinged to a side of the adjusting housing 401 and used to fix the fixing seat 300 when the fixing seat 300 slides to a preset position. The locking button 402 is provided with a second limiting tooth 405.

The fourth spring 403 is arranged in the adjusting housing 401 and used to press the second limiting tooth 405 in one of the limiting tooth slots 312.

When a length of the fixing seat 300 is required to be adjusted, the second limiting tooth 405 is controlled to be separated from the limiting tooth slots 312, and in this case, the fixing seat 300 is able to slide in the adjusting housing 401; and then when the fixing seat 300 is adjusted to the preset position, the second limiting tooth 405 is released and pressed into the limiting tooth slots 312 by the fourth spring 403. Since the second limiting tooth 405 is pressed into the limiting tooth slots 312, the second limiting tooth 405 block the fixing seat 300, such that the fixing seat 300 cannot slide in the adjusting housing 401.

In some examples, an end of the locking button 402 facing away from the second limiting tooth 405 is provided with an unlocking button 407. A rotating shaft 406 is arranged at the middle of the locking button 402 and passes through two sides of the locking button 402. The rotating shaft 406 is rotatably connected to the adjusting housing 401, such that the locking button 402 can rotate in the adjusting housing 401, and thus the second limiting tooth 405 can be separated from the limiting tooth slots 312 when the unlocking button 407 is pressed.

Two ends of the fourth spring 403 respectively abut against an inner wall of the adjusting housing 401 and an end of the locking button 402 provided with the second limiting tooth 405.

As a preferred implementation of the embodiment, two sides of the fixing seat 300 are provided with the limiting tooth slots 312, and two groups of locking buttons 402 are arranged.

In an embodiment of the disclosure, the adjusting seat 400 may further include a limiting push plate 404.

The limiting push plate 404 is slidably connected to the adjusting housing 401 and used to lock the locking button 402. The limiting push plate 404 is provided with a first waist-shaped hole passing through the limiting push plate 404, and the locking button 402 passes through the waist-shaped hole for preventing the locking button 402 from rotating.

In some examples, the adjusting housing 401 is provided with a second waist-shaped hole, and the limit push plate 404 is slidably connected to the adjusting housing 401 via the second waist-shaped hole. When the limit push plate 404 is slid, the limit push plate 404 is clamped under the unlocking button 407 to prevent the unlocking button 407 from being pressed, and thereby preventing the second limit tooth 405 from separating from the limiting tooth slots 312 and achieving locking of the fixing seat 300.

The arrangement of the fixing seat 300 and the adjusting seat 400 is convenient for the user to fix the fixing seat 300 to the automobile seat. In a specific operation, the fixing seat 300 is removed from the adjusting housing 401, the fixing seat 300 is enabled to be passed through a supporting rod of the headrest of the seat from a rear side of the automobile seat, and then the fixing seat 300 is inserted into the adjusting housing 401 and further fixed to the seat.

In an embodiment of the disclosure, the neck pillow may further include a neck pillow connecting structure 200.

The neck pillow connecting structure 200 is fixedly connected to the neck pillow body 100 and is used to adjust a height of the neck pillow body 100, and the adjusting seat 400 is detachably connected to the neck pillow connecting structure 200.

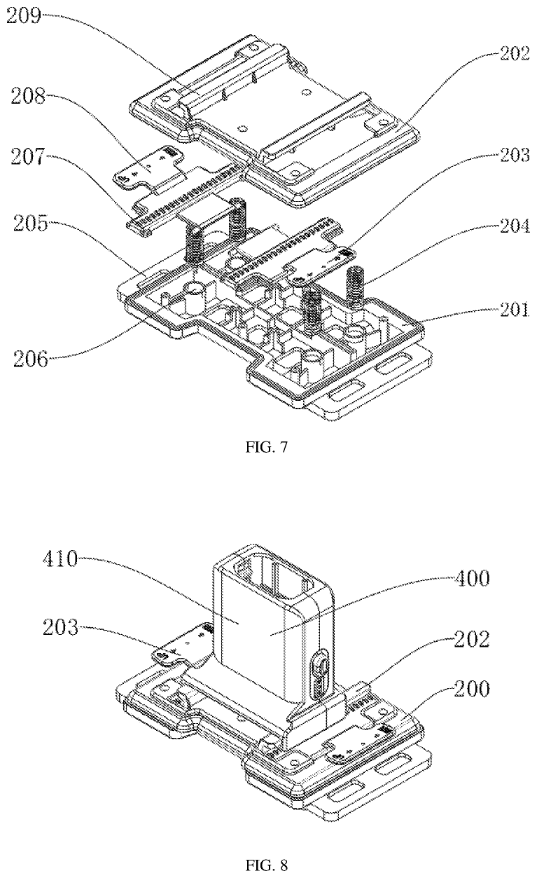

Referring to FIGS. 5, 7 and 8, the adjusting housing 401 is provided with guide rail slots 408, which are U-shaped slots provided respectively at two sides of the adjusting housing 401. The neck pillow connecting structure 200 may include a fixing plate 202 and mounting guide rails 209.

The fixing plate 202 is fixedly connected to the neck pillow body 100.

The mounting guide rails 209 are fixedly connected to the fixing plate 202 and are L-shaped structures arranged on two sides of the fixing plate 202, and the mounting guide rails 209 are clamped in the guide rail slots 408.

When the adjusting seat 400 is fixed, each of the guide rail slots 408 passes through an end of the corresponding mounting guide rail 209, such that the mounting guide rails 209 slide in the guide rail slots 408, in a case that the guide rail slots 408 are connected to the mounting guide rails 209 in a damping way, the mounting guide rails 209 can fix the guide rail slots 408 and enable the neck pillow connecting structure 200 to slide on the adjusting seat 400, thereby adjusting the height of the neck pillow body 100.

As a preferred implementation of the embodiment, each of the guide rail slots 408 is provided with equidistantly arranged second tooth slots, and the neck pillow connecting structure 200 may further include a base plate 201, a limiting plat 203 and a first spring 204.

The base plate 201 is fixedly connected to the neck pillow body 100, and the fixing plate 202 is fixedly connected to the base plate 201.

The limiting plate 203 is arranged between the base plate 201 and the fixing plate 202, and is provided with equidistantly arranged first limiting teeth 207 below each of the mounting guide rails 209.

The first spring 204 is arranged between the limiting plate 203 and the base plate 201, and is used to press the first limiting teeth 207 into the second tooth slot.

When a height of the neck pillow body 100 is required to be adjusted, the limiting plate 203 is pressed, the first limiting teeth 207 are separated from the second tooth slots, and the neck pillow connecting structure 200 is slid, such that the neck pillow connecting structure 200 drives the neck pillow body 100 to slide on the adjusting seat 400 through the base plate 201, thereby the height of the neck pillow body 100 is adjusted. After the adjustment of the height of the neck pillow body 100, the limiting plate 203 is released, such that the first limiting teeth 207 are pressed into the second tooth slots again by the first spring 204, and thereby the limiting plate 203 fixes the guide rail slots 408.

As a preferred implementation of the embodiment, a pressing plate 208 is arranged on the limiting plate 203, which is convenient for the user to press the limiting plate 203.

In some examples, a spring limiting cylinder 206 is arranged in the base plate 201, and the first spring 204 is arranged in the spring limiting cylinder 206 to prevent the first spring 204 from separating from the limiting plate 203, and two ends of the first spring 204 respectively abut against a bottom of the spring limiting cylinder 206 and the limiting plate 203.

In some examples, two ends of the base plate 201 are provided with mounting plates 205, each of the mounting plates 205 is provided with a fixing hole through which the neck pillow body 100 is fixed to the base plate 201.

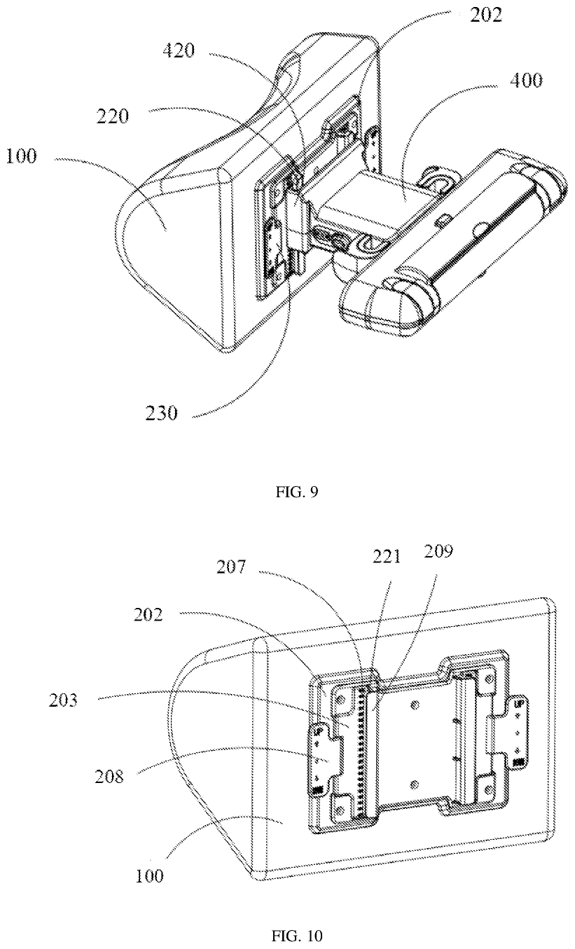

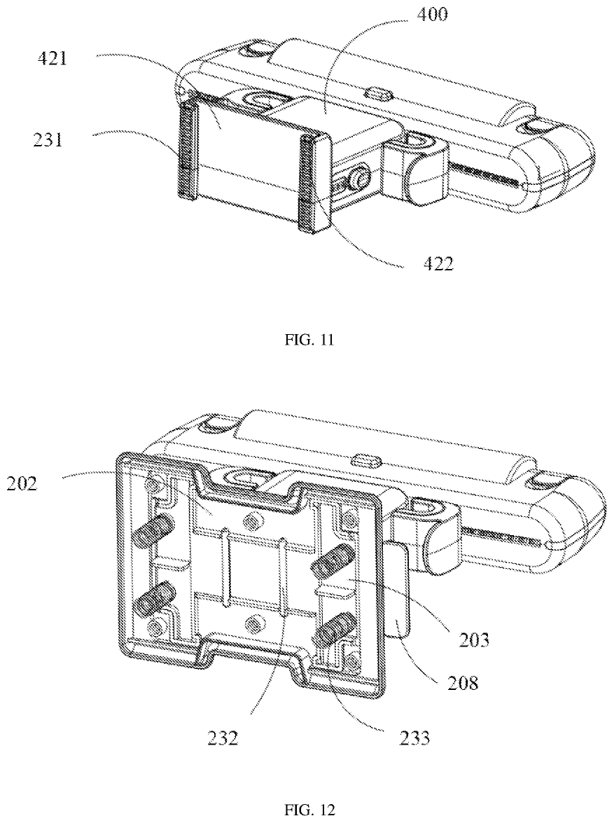

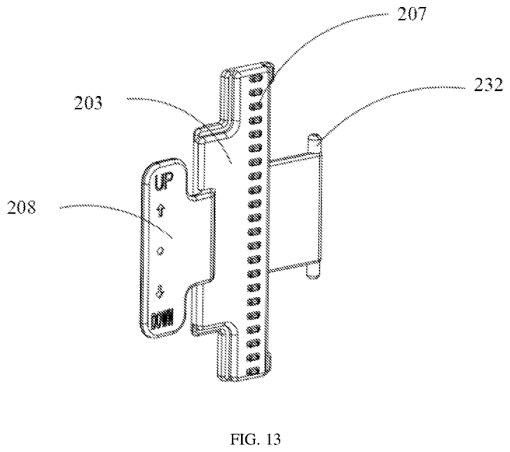

Further, as shown in FIGS. 9 to 13, the neck pillow connecting structure for the neck pillow body 100 of the disclosure includes a fixing plate 202, an installation portion 220, an adjusting seat 400, an assembly portion 420 and a locking device 230.

The fixing plate 202 is assembled with the neck pillow body 100. The installation portion 220 is fixed to an end surface of the fixing plate 202 facing away from the neck pillow body 100. The adjusting seat 400 is fixedly assembled on the automobile seat. The assembly portion 420 is fixed on the adjusting seat 400 and slidably assembled with the installation portion 220. The locking device 230 is arranged on the installation portion 220 or the assembly portion 420, and is used to control the installation portion 220 and the assembly portion 420 to be abutted against each other or separated from each other.

It should be noted that, the neck pillow body 100 specifically refers to a headrest, which plays a role in protecting a head of the user and improving the comfort of the head. The neck pillow connecting structure for the neck pillow body 100 can be applied to, for example, a seat of an automobile or an office seat. When the neck pillow connecting structure is applied to the automobile seat, it can provide side head support for passengers during driving of the automobile, especially during long-distance driving rest, which can not only relieve riding fatigue, but also protect heads and necks of the passengers in traffic accidents and reduce injuries in accidents.

In the embodiment, the neck pillow connecting structure for the neck pillow body 100 is mainly used to facilitate users to adjust a height of the neck pillow body 100 according to their own requirements, and also facilitate the installation of the neck pillow body 100 and the seat. The neck pillow connecting structure for the neck pillow body 100 specifically includes a fixing plate 202, an installation portion 220, an adjusting seat 400, an assembly portion 420 and a locking device 230.

Specifically, a side of the fixing plate 202 of the neck pillow connecting structure for the neck pillow body 100 is assembled with the neck pillow body 100, and the other side of the fixing plate 202 is used to arrange the installation portion 220 to install the neck pillow body 100 on the seat.

The installation portion 220 of the neck pillow connecting structure for the neck pillow body 100 is fixed on an end surface of the fixing plate 202 facing away from the neck pillow body 100. In an embodiment, the installation portion 220 includes mounting guide rails 209 protruding from the end surface of the fixing plate 202 facing away from the neck pillow body 100 in a vertical direction, and groove openings of first sliding grooves 221 at two opposite sides of the mounting guide rails 209 face outward. In a further preferred embodiment, the mounting guide rails 209 are two in number, and the two mounting guide rails 209 are arranged in parallel. By arranging two or more mounting guide rails 209, the stability of the neck pillow body 100 during a height adjustment of the neck pillow body 100 can be improved. It should be explained that the vertical direction in the embodiment is a height adjustment direction of the neck pillow body 100.

The adjusting seat 400 of the neck pillow connecting structure for the neck pillow body 100 is fixedly assembled on the seat. Specifically, the adjusting seat 400 is fixedly installed on an upright post of the seat.

The assembly portion 420 of the neck pillow connecting structure for the neck pillow body 100 is fixed on the adjusting seat 400 and slidably assembled with the installation portion 220. In an embodiment, the assembly portion 420 includes a moving plate 421 arranged on a side of the adjusting seat 400, and two opposite sides of the moving plate 421 are respectively provided with second sliding grooves 422 with groove openings facing inward. When the installation portion 220 is assembled with the assembly portion 420, the groove openings of the first sliding grooves 221 are engaged with the groove openings of the second sliding grooves 422 to complete sliding assembly.

The locking device 230 of the neck pillow connecting structure for the neck pillow body 100 is arranged on the installation portion 220 or the assembly portion 420, and is used to control the installation portion 220 and the assembly portion 420 to abut against each other or separate from each other. When the height of the neck pillow body 100 needs to be adjusted, the locking between the installation portion 220 and the assembly portion 420 by the locking device 230 is released, such that: after the installation portion 220 and the assembly portion 420 are separated from each other, the neck pillow body 100 can be supported by the installation portion 220 to move up and down to a proper position, and then the installation portion 220 and the assembly portion 420 are abutted against each other through the locking device 230 so as to make the neck pillow body 100 be fixed at a designated position of the seat.

In an embodiment, the locking device 230 includes multiple grooves 231, a limiting plate 203, multiple first limiting teeth 207 and an elastic member 233. Specifically, the multiple grooves 231 are arranged on an end surface of the moving plate 421 facing toward the fixing plate 202 and arranged at intervals along a lengthwise direction of the second sliding grooves 422. The number and spacing of the multiple grooves 231 can be determined according to actual conditions, and are not limited herein. The limiting plate 203 is adapted to a moving opening preset on an outer side of the fixing plate 202, and an end of the limiting plate 203 is hinged to an inner side of the fixing plate 202 through a rotating shaft 232, such that the limiting plate 203 can rotate around the rotating shaft 232. The multiple first limiting teeth 207 are arranged on the limiting plate 203, and correspond to and adapt to the multiple grooves 231. The elastic member 233 is arranged between a bottom of the limiting plate 203 and an outer wall of the neck pillow body 100, can be springs or elastic sheets, and can provide the limiting plate 203 with an elastic force to rotate around the rotating shaft 232 in the direction close to the moving plate 421. When the height of the neck pillow body 100 needs to be adjusted, the limiting plate 203 is pressed to rotate around the rotating shaft 232 to compress the elastic member 233, such that the multiple first limiting teeth 207 on the limiting plate 203 are separated from the multiple grooves 231 on the moving plate 421 and thereby the locking device 230 between the installation portion 220 and the assembly portion 420 is released. In this case, the neck pillow body 100 can be supported by the user to move up and down to a proper position, and the pressing of the limiting plate 203 is stopped to make the limiting plate 203 rotate around the rotating shaft 232 towards the moving plate 421 under the elastic force of the elastic member 233, such that the multiple first limiting teeth 207 on the limiting plate 203 abut against the multiple grooves 231 on the moving plate 421, and thus the neck pillow body 100 is fixed at the designated position of the seat. With the neck pillow connecting structure for the neck pillow body 100 of the disclosure, when the height of the neck pillow body 100 is adjusted, it is not only convenient to operate, but it is also time-saving and labor-saving. Further, the neck pillow connecting structure can replace the existing bolt fixing manner.

In another embodiment, a side of the moving plate 421 facing away from the rotating shaft 232 is provided with a pressing plate 208 extending outward, which is convenient for the user to press the limiting plate 203.

Moreover, as shown in FIGS. 9 to 13, a seat of an automobile is provided, which includes the neck pillow connecting structure for the neck pillow body 100 as described above.

In the embodiment, the neck pillow connecting structure for the neck pillow body 100 includes a fixing plate 202, an installation portion 220, an adjusting seat 400, an assembly portion 420 and a locking device 230. The fixing plate 202 is assembled with the neck pillow body 100. The installation portion 220 is fixed to an end surface of the fixing plate 202 facing away from the neck pillow body 100. The adjusting seat 400 is fixedly assembled on the automobile seat. The assembly portion 420 is fixed on the adjusting seat 400 and slidably assembled with the installation portion 220. The locking device 230 is arranged on the installation portion 220 or the assembly portion 420, and is used to control the installation portion 220 and the assembly portion 420 to be abutted against or separated from each other. With the neck pillow connecting structure for the neck pillow body 100 of the disclosure, when the height of the neck pillow body 100 is adjusted, it is not only convenient to operate, but it is also time-saving and labor-saving. Further, the neck pillow connecting structure can replace the existing bolt fixing manner.

Although the embodiments of the disclosure have been shown and described, it will be understood by those of ordinary skill in the art that various changes, modifications, substitutions and modifications can be made to these embodiments without departing from the principles and spirit of the disclosure, and the scope of the disclosure is defined by the appended claims and equivalents thereof.

What is claimed is:

1. A clamping device for an intelligent apparatus, adapted for fixing the intelligent apparatus onto an automobile seat, comprising:
a T-shaped fixing seat, configured to be fixed onto the automobile seat; and
a plate clamping mechanism, arranged in the fixing seat and configured to clamp the intelligent apparatus;
wherein the plate clamping mechanism comprises:
a first clamping block, arranged in the fixing seat and being L-shaped; and
a second clamping block, slidably connected into the first clamping block, wherein the first clamping block and the second clamping block are configured to cooperatively clamp the intelligent apparatus.

2. The clamping device according to claim 1, wherein the fixing seat comprises:
a T-shaped fixing housing, being hollow inside;
two groups of clamping portions, slidably connected into the fixing housing, respectively arranged at two ends of a part of the fixing housing parallel with a neck pillow body and configured to fix the fixing seat on the automobile seat; and
second springs, arranged in the fixing housing and configured to respectively press the two groups of clamping portions against the automobile seat.

3. The clamping device according to claim 2, wherein the clamping device further comprises:
a first limiting slot, located in the fixing seat;
a telescopic bar, rotatably connected onto the first clamping block and slidably arranged in the first limiting slot; and
an adjustment button, arranged in the fixing seat and configured to fix the telescopic bar in the first limiting slot.

4. The clamping device according to claim 3, wherein the clamping device further comprises:
a sixth spring, arranged in the telescopic bar, wherein two ends of the sixth spring respectively abut against the telescopic bar and the fixing seat, and the sixth spring is configured to eject the plate clamping mechanism from the fixing seat.

5. The clamping device according to claim 1, wherein the plate clamping mechanism further comprises:
shafts, fixedly connected onto the second clamping block and slidably connected into the first clamping block; and
fifth springs, sleeved on the spring shafts, wherein an end of the fifth spring abuts against an end of the shaft facing away from the second clamping block and the other end of the fifth spring abuts against the first clamping block, and the fifth springs are configured to control the second clamping block to clamp the intelligent apparatus.

6. A multifunctional automobile neck pillow, comprising the clamping device for an intelligent apparatus according to claim 1, and further comprising:
a neck pillow body, fixedly connected to the fixing seat; and
a hook, arranged on the fixing seat and configured for hanging an object.

7. The multifunctional automobile neck pillow according to claim 6, wherein the neck pillow further comprises:
an adjusting seat, fixedly connected to the neck pillow body and configured to adjust a distance between the plate clamping mechanism and the neck pillow body, wherein an end of the fixing seat near to the neck pillow body is arranged in the adjusting seat.

8. The multifunctional automobile neck pillow according to claim 7, wherein a portion of the fixing seat arranged in the adjusting seat is provided with equidistantly arranged limiting tooth slots, and the adjusting seat comprises:
an adjusting housing, fixedly connected to the neck pillow body and being hollow inside, wherein the fixing seat is slidably connected to the adjusting housing;
a locking button, hinged to a side of the adjusting housing and configured to fix the fixing seat, wherein the locking button is provided with a second limiting tooth; and
a fourth spring, arranged in the adjusting housing and configured to press the second limiting tooth in one of the limiting tooth slots.

9. The multifunctional automobile neck pillow according to claim 6, wherein the neck pillow further comprises:
a neck pillow connecting structure, fixedly connected to the neck pillow body and configured to adjust a height of the neck pillow body;
wherein the neck pillow connecting structure comprises:
a fixing plate, assembled with the neck pillow body;
an installation portion, fixed to an end surface of the fixing plate facing away from the neck pillow body;
an adjusting seat, fixedly assembled on the automobile seat;
an assembly portion, fixed on the adjusting seat and slidably assembled with the installation portion; and
a locking device, arranged on the installation portion or the assembly portion, and configured to control the installation portion and the assembly portion to be abutted against or separated from each other.

10. The multifunctional automobile neck pillow according to claim 9, wherein the installation portion comprises:
mounting guide rails, protruding from the end surface of the fixing plate facing away from the neck pillow body in a vertical direction, wherein groove openings of first sliding grooves at two opposite sides of the mounting guide rails face outward.

11. The multifunctional automobile neck pillow according to claim 10, wherein the mounting guide rails are two in number, and the two mounting guide rails are parallel to each other.

12. The multifunctional automobile neck pillow according to claim 10, wherein the assembly portion comprises:
a moving plate, arranged on a side of the adjusting seat, wherein two opposite sides of the moving plate are respectively provided with second sliding grooves with groove openings facing inward.

13. The multifunctional automobile neck pillow according to claim 9, wherein the locking device comprises:
a plurality of grooves, arranged on an end surface of the moving plate facing toward the fixing plate and arranged at intervals along a lengthwise direction of the second sliding grooves;
a limiting plate, adapted to a moving opening preset on an outer side of the fixing plate, wherein an end of the limiting plate is hinged to an inner side of the fixing plate through a rotating shaft;
a plurality of first limiting teeth, arranged on the limiting plate and corresponding to and adapted to the plurality of grooves; and
an elastic member, arranged between a bottom of the limiting plate and an outer wall of the neck pillow body.

14. The multifunctional automobile neck pillow according to claim 13, wherein the elastic member comprises springs or elastic sheets.

15. The multifunctional automobile neck pillow according to claim 13, wherein a side of the moving plate facing away from the rotating shaft is disposed with a pressing plate extending outward.
